(19) United States
(12) Patent Application Publication
(10) Pub. No.: US 2024/0115452 A1
(43) Pub. Date: Apr. 11, 2024

(54) WIRELESS REMOTE ASSEMBLY AND METHOD FOR MEDICAL CHAIR

(71) Applicant: HAAG-STREIT USA, INC, Mason, OH (US)

(72) Inventors: Terry Birchler, Blackiick, OH (US); Erik Turocy, Bexley, OH (US); Jeffery Accursi, Columbus, OH (US)

(21) Appl. No.: 17/767,735

(22) PCT Filed: Oct. 12, 2020
(86) PCT No.: PCT/US20/55237

§ 371 Date: Apr. 8, 2022

Related U.S. Application Data
(63) Continuation of application No. 29/709,123, filed on Oct. 11, 2019, now Pat. No. D912635.
Application No. 29/709,123 is a continuation of application No. 29/709,128, filed on Oct. 11, 2019, now Pat. No. D907588.
(60) Provisional application No. 62/914,005, filed on Oct. 11, 2019.

(51) Int. Cl. A61G 15/02

(52) U.S. Cl. CPC A61G 15/02; A61G 2203/12; A61G 2203/30

(57) ABSTRACT

A system for a medical chair that has a chair assembly having a plurality of movable components, a control system that selectively controls the movable components, and a wireless controller that communicates wirelessly with the control system to modify a configuration of the movable components.

### CROSS-REFERENCE TO RELATED APPLICATION

The present disclosure is a U.S. national phase entry of International Application No. PCT/US2020/055237 filed on Oct. 12, 2020 and which claims the benefit of U.S. Provisional Application No. 62/914,005 filed on Oct. 11, 2019 along with U.S. Design Application No. 29/709,123 filed Oct. 11, 2019 and U.S. Design Application No. 29/709,128 filed Oct. 11, 2019, the contents of which are hereby incorporated herein in their entirety.

### TECHNICAL FIELD

The present disclosure is generally related to a remote for a medical chair and more particularly to a wireless hand and foot remote for a medical chair.

### BACKGROUND

Medical chairs often have movable functionality to allow the medical professional to position a patient in a desired orientation. Often, the positioning of the medical chair is controlled by a remote or user input that is wired or formed into the chair itself. This restricts the medical professional's access to the remote and adds chords and the like to the area which can become tangled with the patient, medicals tools, medical professional, or any combination thereof.

### SUMMARY

One embodiment is a system for a medical chair. The system has a chair assembly having a plurality of movable components, a control system that selectively controls the movable components, and a wireless controller that communicates wirelessly with the control system to modify a configuration of the movable components.

In one example of this embodiment, the wireless controller includes both a wireless foot controller and a wireless hand controller both in communication with the control system. In another example, the wireless controller has an elevation button that instructs the control system to raise or lower the chair assembly. In part of this example, the wireless controller has a tilt button that instructs the control system to move the chair assembly toward a reclined or upright position.

In yet another example of this embodiment, the wireless controller has at least one preset button that communicates to the control system a preset configuration of the chair assembly when depressed. As part of this example, the preset button also communicates an illumination level of a light source to the control system when depressed.

In another example of this embodiment, the wireless controller has a lighting rocker that selectively communicates an illumination level to the control system when depressed, wherein the control system alters the illumination level of a light source responsive to input from the lighting rocker. Part of this example has a lighting toggle on the wireless controller that selects one light source of a plurality of light sources to be altered by the lighting rocker. Another part of this example has a light level indicator on the wireless remote that is configured to indicate the lighting level of the light source.

Another embodiment of this disclosure is a chair assembly control system that has a movable chair assembly having a selectively movable chair thereon, an equipment support section configured to hold at least one instrument, and a controller configured to selectively alter the orientation of the chair and the orientation of the at least one instrument on the equipment support section. The controller is programmable to automatically alter the orientation of the chair and the at least one instrument responsive to a user input.

One example of this embodiment has a light on the equipment support that is selectively powered by the controller responsive to the user input. In another example the chair has a plurality of sensors coupled thereto to identify the orientation of the chair and the user input is programmable to alter the orientation of the chair to a programmed orientation when the user input is selected.

In another example of this embodiment the equipment support has a plurality of sensors coupled thereto to identify the orientation of the at least one instrument and the user input is programmable to alter the orientation of the at least one instrument to a programmed orientation when the user input is selected.

In another example of this embodiment has at least one programmable preset wherein a user can select a preferred orientation of the chair and the at least one instrument to be associated with the at least one programmable preset. In one part of this example, at least one lighting setting is selected to be associated with the at least one programmable preset.

Another example of this embodiment has an instrument holding assembly configured to hold a portable instrument, wherein the controller is programmable to automatically alter a setting of the portable instrument responsive to the user input.

Another embodiment of this disclosure includes a method for controlling an examination room having a medical chair assembly. The method includes providing a control system in communication with a chair assembly, an equipment support section, a light assembly, and at least one portable controller and selectively controlling the orientation of the chair assembly, at least one instrument support of the equipment support section, and the light assembly responsive to an input on the at least one portable controller.

In one example of this embodiment, the at least one portable controller is at least one of a wireless hand controller and a wireless foot controller that communicate with a controller of the control system wirelessly. Another example includes providing at least one preset input on the at least one portable controller, selectively programming the at least one preset input to establish a specific orientation of the chair assembly and the at least one instrument of the equipment support section, and automatically altering the positioning of the chair assembly and the at least one instrument of the equipment support section to the specific orientation when the at least one preset input is selected by a user. In part of this example, selectively programming the at least one preset input establishes a lighting preference for at least one of a lighting assembly of the equipment support section and a lighting system of the examination room.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a schematic view of a medical chair assembly with wireless remotes;

FIG. 2 is a top view of one embodiment of a wireless hand remote;

FIG. 3a is an elevated perspective view of the wireless hand remote of FIG. 2;

FIG. 3b is a side view of the wireless hand remote of FIG. 2;

FIG. 3c is a front view of the wireless hand remote of FIG. 2;

FIG. 4 is a top view of a wireless foot remote;

FIG. 5a is an elevated perspective view of the wireless foot remote of FIG. 4;

FIG. 5b is a side view of the wireless foot remote of FIG. 4;

FIG. 5c is a side view of the wireless foot remote of FIG. 4;

FIG. 6 is a schematic view of the wireless hand remote of FIG. 2 and the wireless foot remote of FIG. 4 communicating with a control system;

FIG. 7 is a front view of a button assembly;

FIG. 8 is a front view of another embodiment of a hand remote;

FIG. 9 is another embodiment of a foot remote;

FIG. 10 is a front view of an instrument holding assembly having portable instruments therein;

FIG. 11 is a schematic representation of one embodiment of the present disclosure;

FIG. 12 is a logic flowchart of a programming mode for a medical chair assembly;

FIGS. 13a-13b are logic flowcharts directed towards programming presets of the medical chair assembly;

FIG. 14 is a logic flowchart to program an instrument of the medical chair assembly;

FIG. 15 is a logic flowchart to program a light assembly of the medical chair assembly;

FIG. 16 is a logic flowchart to program a chair of the medical chair assembly;

FIG. 17 is a logic flowchart to save settings of the medical chair assembly;

FIG. 18 is a logic flowchart to re-program presets of the medical chair assembly;

FIGS. 19a-19c are logic flowcharts directed towards programming an instrument of the medical chair assembly;

FIGS. 20a-20c are logic flowcharts directed towards programming lights of the medical chair assembly;

FIGS. 21a-21b are logic flowcharts directed towards programming chair of the medical chair assembly;

FIG. 22 is a logic flowchart to save settings of the medical chair assembly;

FIG. 23 is a logic flowchart directed towards programming profiles of the medical chair assembly;

FIG. 24 is a logic flowchart to program a foot remote of the medical chair assembly;

FIGS. 25a-25c are logic flowcharts directed towards programming hand instruments of the medical chair assembly;

FIG. 26 is a logic flowchart directed towards operating modes of the medical chair assembly;

FIG. 27 is a logic flowchart directed towards automation settings of the medical chair assembly;

FIGS. 28a-28b are logic flowcharts directed towards button inputs of the medical chair assembly;

FIG. 29 is a logic flowchart directed towards clearing presets of the medical chair assembly;

FIG. 30 is a logic flowchart directed towards clearing presets of a foot controller of the medical chair assembly;

FIG. 31 is a logic flowchart directed towards clearing saved profiles of the medical chair assembly; and

FIG. 32 is a logic flowchart directed towards exiting a programming mode of the medical chair assembly.

Corresponding reference numerals are used to indicate corresponding parts throughout the several views.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

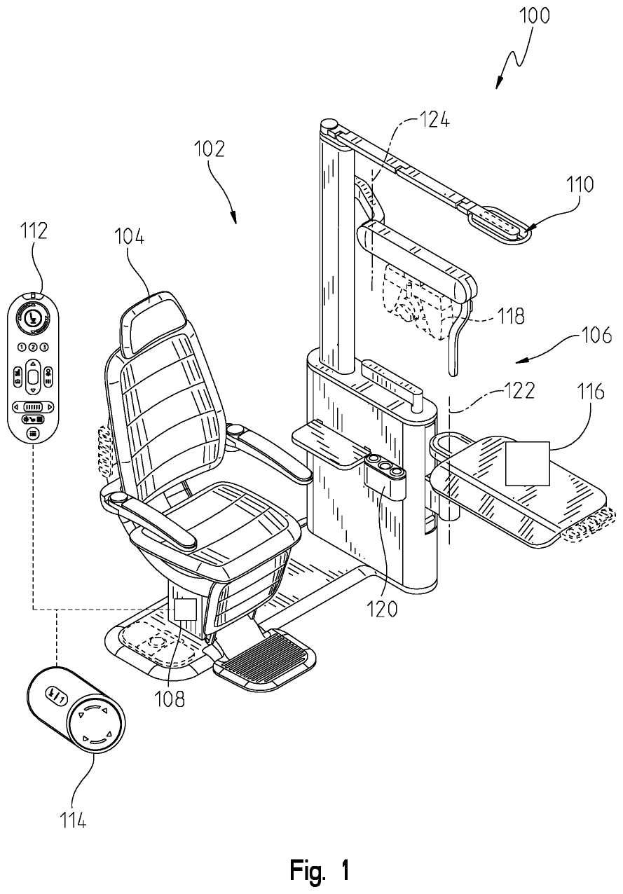

FIG. 1 illustrates a wireless medical chair system 100. The chair system 100 has a chair assembly 102 having a patient chair 104 and an equipment support section 106. The chair assembly 102 may be like the chair assembly described in International Publication No. WO 2020/086960 titled “INTEGRATED PATIENT SUPPORT AND EQUIPMENT FOR MEDICAL PROCEDURES” and filed Oct. 25, 2019, the contents of which are hereby incorporated herein by reference. The chair assembly 102 may have several features that articulate to allow a medical professional to position the chair 104 and portions of the equipment support section 106 in a desirable orientation for the medical professional and patient. More specifically, the patient chair may raise and lower, adjust back tilt, and raise a leg support among other things. Similarly, the equipment support section 106 may have an instrument tray configured to hold a slit lamp 116 (exemplary representation in FIG. 1) that is repositionable, a light assembly 110 that is selectively illuminated in either a direct configuration or an ambient configuration, a phoropter 118 that is pivotable between a user position and a side position and height adjustable, and an instrument holding assembly 120 configured to hold one or more portable instruments 1002 among other things.

The chair assembly 102 may articulate as discussed herein utilizing actuators or the like. More specifically, a control system 108 may selectively control the actuators to adjust the orientation of the corresponding components of the chair assembly 102. Further the control system 108 may selectively control the illumination intensity of the light assembly 110 of the equipment support section among other things.

The control system 108 may have one or more controller therein that has a memory unit and processor capable of storing algorithms and the like thereon and executing commands. Further, the control system 108 may have a wireless receiver, transceiver, or the like that is capable sending and/or receiving wireless signals. In one aspect of this disclosure, the control system 108 may wirelessly communicate with a hand controller 112 and/or a foot controller 114. The hand and foot controllers 112, 114 may utilize any known wireless protocol to communicate with the control system 108 to thereby control the configuration of the chair assembly 102. More specifically, the hand and foot controllers 112, 114 may allow the medical professional to wirelessly communication with the control system 108 to adjust the orientation of the patient chair 104 or equipment support section 106. Further, the hand and foot controllers 112, 114 may allow the medical professional to alter the illumination intensity of the light assembly 110 among other things.

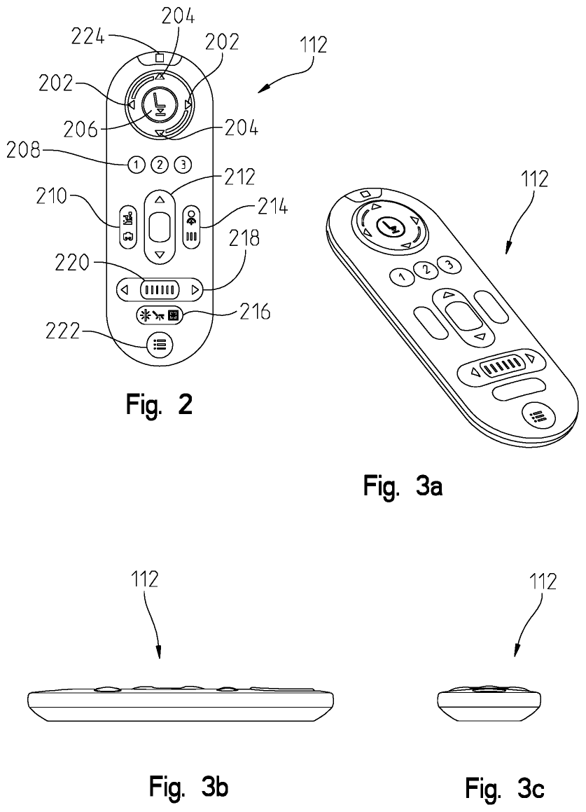

Referring now to FIG. 2, the hand controller 112 is illustrated in more detail. The hand controller 112 may have circular button assembly along a top portion that has tilt commands 202 on either side thereof. The tilt commands may alter the reclining configuration of the patient chair 104. Similarly, the circular button assembly may have chair elevation commands 204 on the top and bottom thereof. The chair elevation commands 204 may control the elevation of the patient chair 104 and allow the medical professional to raise or lower the patient chair 104 by selecting the corresponding elevation command 204. Further, the center of the circular button assembly may have a home button 206. The home button 206 may return the chair assembly 102 to a home position when pressed. The home position may be where the patient chair 104 is in a lowered and neutrally reclined state. Further, in one embodiment of this disclosure the home position returns the equipment support section 106 to a neutral position and may alter the illumination setting of the light assembly 110.

Beneath the circular button assembly may be a plurality of preset buttons 208. Each of the preset buttons 208 may be assigned to a particular configuration of the chair assembly 102. Accordingly, when a preset button 208 is pressed, the control system 108 may manipulate the chair assembly 102 to the preset configuration. In one non-exclusive example, there may be three separate preset buttons 208. However, other embodiments considered herein utilize more or less than three preset buttons.

In another aspect of this disclosure, the hand controller 112 may have an instrument toggle 210 that allows the medical professional to select which instrument an instrument rocker 212 may control. The instrument toggle 210 may toggle through available instruments on the equipment support section 106 and allow the medical professional to alter the configuration of the selected instrument with the instrument rocker 212. For example, the instrument toggle 210 and rocker 212 may allow the medical professional to select and control features of a slit lamp or phoropter 104 among other thing.

In yet another aspect of this disclosure, the hand controller 112 may have a doctor profile toggle 214. The doctor profile toggle 214 may allow the medical professional to select one of a plurality of programmed doctor profiles. Each doctor profile may have corresponding preset positions programmed for each of the preset buttons 208 as well as specific instrument toggle 210 options among other things. In one non-exclusive example, the doctor profile toggle 214 may have three separate doctor profile options. However, more or less than three doctor profile options are also considered herein for the doctor profile toggle 214.

The hand controller 112 may also have a lighting toggle 216. The lighting toggle 216 may allow the medical professional to select a specific light source to control with a lighting rocker 218. More specifically, the lighting toggle 216 may allow the user to select from one or more of a room light, a direct light, or an ambient light among others. In this example, the control system 108 may also communicate with a room lighting system to selectively alter the illumination of the room lighting. Further, the light assembly 110 may have both direct and ambient options that can be selected and controlled by the lighting toggle 216 and rocker 218. Accordingly, the user can select the lighting source with the lighting toggle 216 and alter the illumination intensity of that lighting source by engaging the lighting rocker 218.

In one aspect of this disclosure, the lighting rocker 218 may have a light level indicator 220 thereon. The light level indicator 220 may illuminate bars or the like to indicate the illumination level of the light source selected by the lighting toggle 216. More specifically, if the light source is fully illuminated, the light level indicator 220 may illuminate all bars thereon as an indication of the fully illuminated source. Alternatively, if the light source is minimally illuminated, the light level indicator 220 may illuminate only one bar indicating the minimal illumination. The light level indicator 220 may have any number of bars to correspond with any percentage of illumination of the light source. Further, while bars are discussed herein, this disclosure contemplates utilizing any indicator capable of identifying the illumination level of the source.

The hand controller 112 may also have a program button 222 that allows the user to enter a program mode of the hand controller 112. The program mode may be illustrated on a user interface that allows the user to program the preset buttons 208, doctor profile toggle 214, and lighting toggle 216 among others. Alternatively, the program button 222 may allow the user to selectively enter a program mode that is not shown on a user interface but rather identified by the hand controller 112 via audible, visual, or haptic feedback. Regardless of the form, the program button 222 allows the user to enter a program mode to pre-program certain components of the hand remote 112.

At the topmost portion of the hand remote 112 may be a stop button 224. The stop button 224 may stop any motor or actuator that is currently functioning on the chair assembly 102. In one non-exclusive example, if a preset button 208 is selected the control system 108 may begin raising the patient chair 104 to the preset position. If an obstruction is identified while the control system 108 is raising the patient chair 104, the user may press the stop button 224 to instruct the control system 108 to stop raising the patient chair 104. The stop button 224 may stop any motion of the chair assembly 102 when pressed. Alternatively, another embodiment does not have a stop button at all. Rather, if the chair 104 is in motion and any other button of the controller is pressed the motion will stop. Accordingly, this disclosures contemplates embodiments without a stop button at all as well.

FIGS. 3a-3c illustrate various views of the hand remote 112 of FIG. 2.

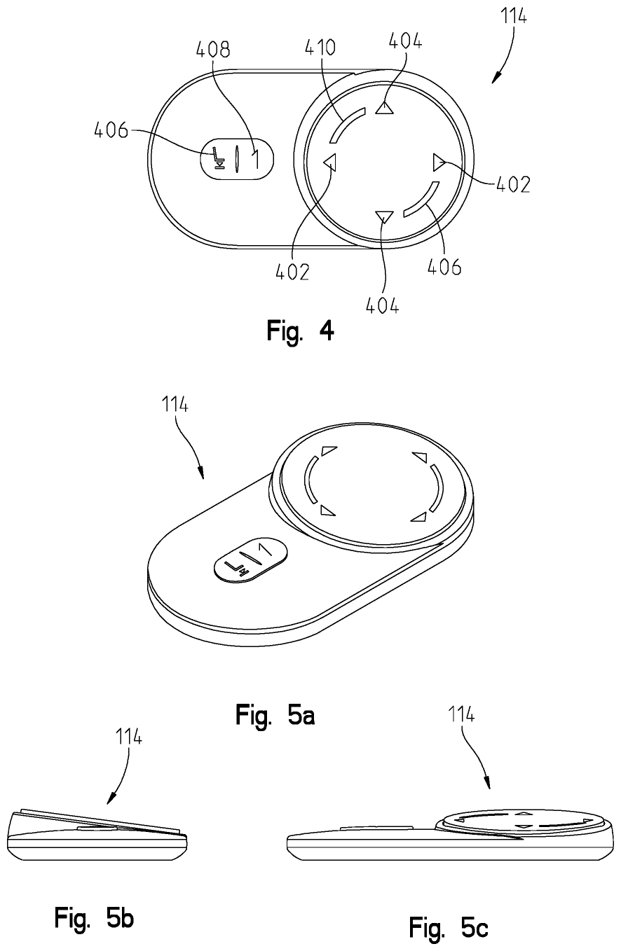

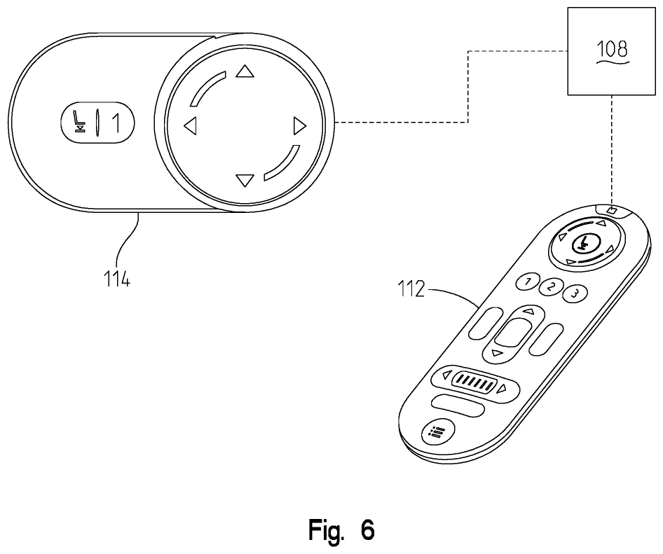

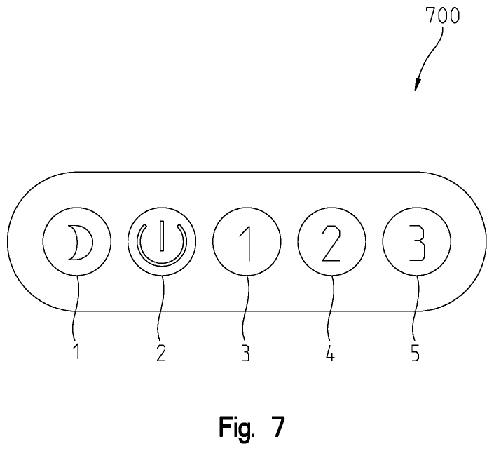

Referring now to FIG. 4, the foot control 114 is illustrated in more detail. The foot controller 114 may have many similar features as the hand controller 112. In one aspect of this disclosure, both the hand and foot controller 112, 114 may be utilized to implement the teachings discussed herein. Further, the control system 108 communicates with both the hand and foot controller 112, 114 and implements the commands received from either one. Alternatively, this disclosure also contemplates utilizing only one of the hand controller 112 or foot controller 114.

The foot controller 114 may have circular button assembly that has tilt commands 402 on either side thereof. The tilt commands may alter the reclining configuration of the patient chair 104. Similarly, the circular button assembly may have chair elevation commands 404 on the top and bottom thereof. The chair elevation commands 404 may control the elevation of the patient chair 104 and allow the medical professional to raise or lower the patient chair 104 by selecting the corresponding elevation command 404. Further, an offset portion along the bottom right of the circular button assembly as illustrated in FIG. 4 may have a home button 406. The home button 406 may return the chair assembly 102 to a home position when pressed. The home position may be where the patient chair 104 is in a lowered and neutrally reclined state. Further, in one embodiment of this disclosure the home position returns the equipment support section 106 to a neutral position and may alter the illumination setting of the light assembly 110.

The circular button assembly of the foot controller 114 may also have a procedure position 410 along an offset portion thereof in the top left of the circular button assembly as illustrated in FIG. 4. The procedure position 410 may be a preset position that raises and reclines the patient chair 104 to a desired orientation for a medical procedure. Alternatively, the procedure position 410 may be a position of the patient chair 104 programed into the control system 108 by the medical professional.

The foot controller 114 may also have a preset button 408. The preset button 408 may be assigned to a particular configuration of the chair assembly 102. Accordingly, when the preset button 408 is pressed, the control system 108 may manipulate the chair assembly 102 to the preset configuration. While only one preset button 408 is illustrated, in other non-exclusive examples there may be more than one preset button 408. Next to the preset button 408 may be another chair home button 406.

Referring now to FIG. 7, a stand button assembly 700 is illustrated. This button assembly 700 may be position anywhere on the chair system 100 that allows a user to access the button assembly 700. In one non-exclusive embodiment, the button assembly 700 is on the equipment support section 106. However, in other embodiments the button assembly 700 may be positioned on the chair 104 as well.

The button assembly 700 may have a system sleep button 1, a power/reset button 2, a first stand button 3, a second stand button 4, and a third stand button 5. The button assembly 700 may provide inputs to the control system 108 to store data and control the chair system 100.

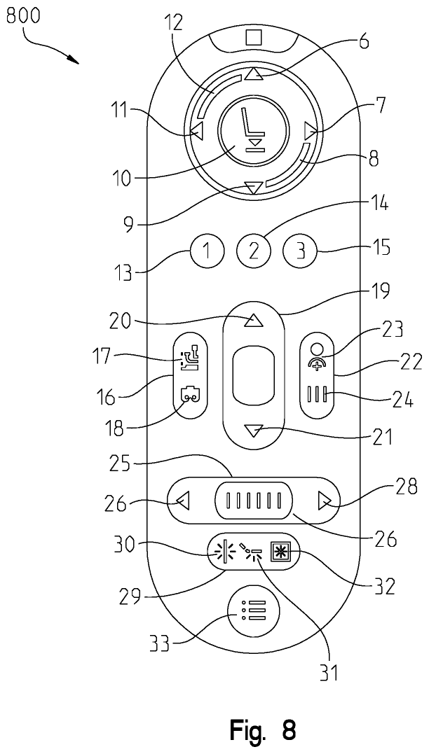

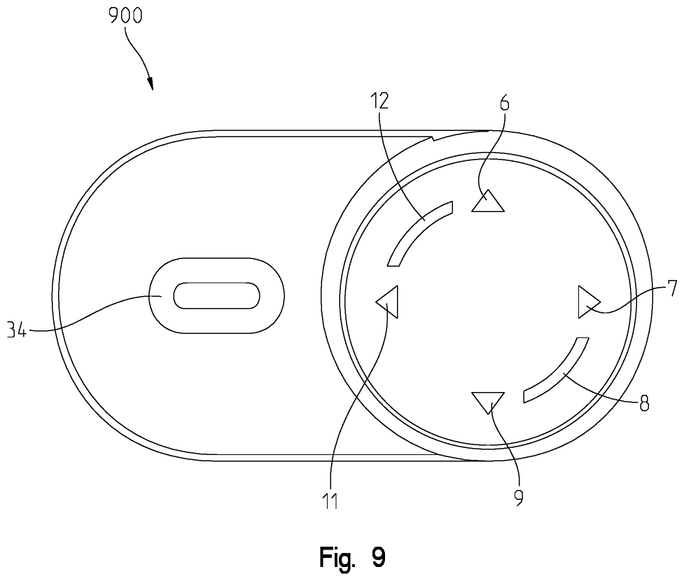

Another embodiment of a hand controller 800 illustrated in FIG. 8. The hand controller may wirelessly communicate with the control system 108 to store information and provide response instructions to the chair system 100 among other things. The hand controller 800 may also receive data from the control system 108 indicating the status of the components of the chair system 100. The hand controller 800 may have a plurality of buttons and lights that provide inputs for a user into the control system 108 and indications regarding the current state of the chair system 100.

More specifically, the hand controller 800 may have a chair up arrow 6 and a chair down arrow 9 that allow the user to selectively raise and lower the chair 104. The hand controller 800 may also have a chair tilt up arrow 7 and a chair tilt back arrow 11 that selectively tilt the chair 104. A chair home button 10 may be selectively engaged to return the chair system 100 to a home preset configuration. A chair up and tilt back arrow 12 may allow a user to selectively simultaneously raise the chair 104 while tilting it backwards. A chair tilt back and down section 8 may be selectively engaged to substantially simultaneously lower the chair 104 while returning the chair back to an upright configuration. A first preset 13, second preset 14, and third preset 14 may correspond with preset configurations of the chair system 100. An instrument selector button 16 may allow a user to select an instrument. As one non-exclusive example, the selectable instrument may be a slit lamp and the hand controller 800 may have a corresponding slit lamp icon 17 that is selectively lit to indicate a status of the slit lamp. In another example, the selectable instrument may be a phoropter and the hand controller 800 may have a corresponding phoropter icon 17 that is selectively lit to indicate a status of the slit lamp. While specific instruments are presented herein, this disclosure applies to any number and type of instrument that may be helpful to a caregiver.

The hand controller 800 may also have and instrument adjustment 19 having an instrument up arrow 20 and an instrument down arrow 21. The instrument adjustment may provide inputs for a user to modify settings of any instrument of the chair system 100.

The hand controller 800 may also have a profile selector 22 that has a doctor profile icon 23 and a profile icon assembly 24. The doctor profile icon 23 may be selectively illuminated to identify that a specific doctor profile is being considered and the presets 13, 14, 15 are presets specifically intended for the doctor associated with the profile icon assembly 24. More specifically, the profile icon assembly 24 may have a plurality of bars each of which can display one or more color. The color and number of bars illuminated on the profile icon assembly 24 may identify the specific doctor profile for which the control system 108 is utilizing for preset purposes and the like. In other words, the profile icon assembly 24 identifies which user's preferences are being utilized by the control system.

The hand controller may also have a lighting adjustment 25 with lighting down arrows 26, lighting up arrows 28, and lighting level bars 27. The lighting level bars 27 may indicate the intensity for which the corresponding light source is illuminating. More specifically, the lighting level bars 27 may be a plurality of bars that are selectively illuminated. If all of the bars are illuminated, the corresponding light source may be at 100% illumination. However, if the light source is only at 50% illumination, only half of the lighting level bars 27 may be illuminated. The number of bars may vary, and this disclosure contemplates using more and fewer bars than those shown. Further, other embodiments may not use bars at all but rather have a different graphical or textual representation of the selected illumination intensity.

The hand controller 800 may also have a light selector 29 having an ambient light icon 30, a direct light icon 31, and a room light icon 32. The light selector 29 may be selectable by a user to cycle through the light being controller by the lighting adjustment 25. In the embodiment presented herein, the hand controller 800 may control an ambient light of the chair system 100, a direct light of the chair system 100, or a room light in the surrounding room. The light selector 29 may illuminate the icon 30, 31, 32 being controlled by the lighting adjustment 25. While specific lights are discussed herein, other lights may be selectably controlled as well and the present embodiment is just one example.

The hand controller 800 may also have a program button 33 that allows the user to selectably program the control system 108. The program button 33 may be selectable by the user to put the control system 108 in a program mode wherein the user may select presets associated with the preset buttons 13, 14, 15 among other things.

Referring now to FIG. 9, another embodiment of a wireless foot controller 900 is illustrated. The wireless foot controller 900 may have a similar chair up arrow 6, chair down arrow 9, chair tilt up arrow 7, chair tilt back arrow 11, chair up and tilt back selection 12, and chair down and tilt up selection 8 as the hand remote 800. The foot controller 900 may also have a program button 34 that is selectively engageable by a user to put the control system 108 in a program mode among other things. Further, the foot controller 900 may communicate wirelessly with the control system 108 to selectively provide inputs to control the chair system 100.

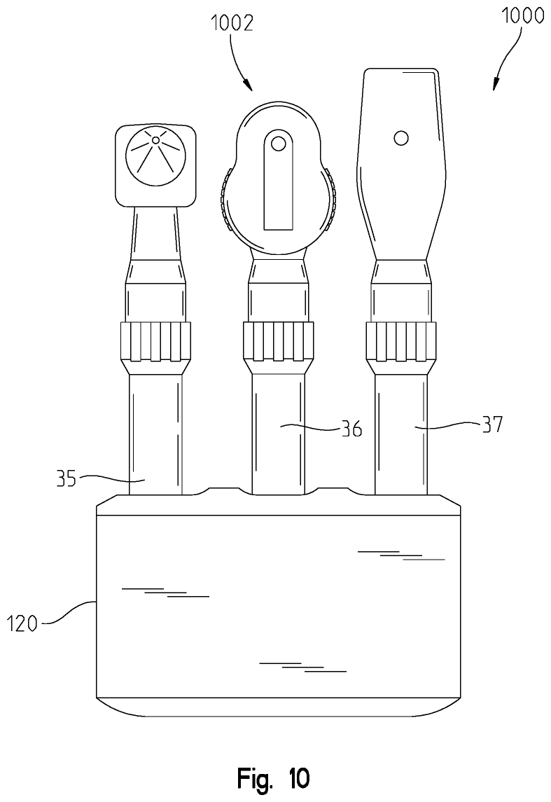

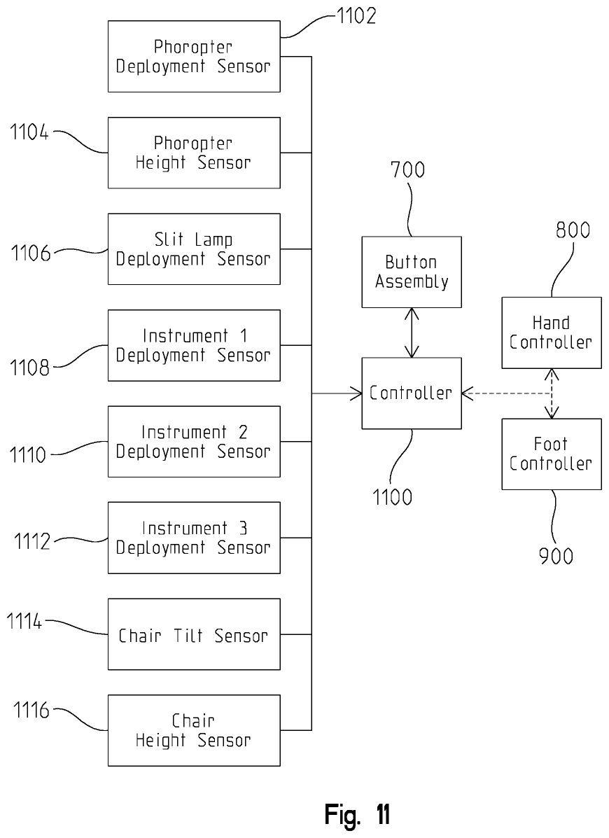

In one embodiment of this disclosure, the chair system 100 may have an instrument holding assembly 1000 as illustrated in FIG. 10. The assembly 1000 may be configured to hold instruments to be used by the medical provider on the type of patient expected to be in the chair 104. The assembly 1000 may provide a first instrument well 35, a second instrument well 36 and a third instrument well 37 each configured to hold a corresponding instrument. In addition to holding the corresponding instrument, the instrument wells 35, 36, 37 may charge any electronics in the corresponding instruments. Further still, each instrument well 35, 36, 37 may have a sensor therein that identifies the presence of the corresponding instrument to the control system 108.

Referring now to FIG. 11, a schematic representation of one embodiment of the control system 108 is illustrated. The control system 108 may have a controller 1100 that has one or more processor and access to one or more memory unit to store executable commands, data, algorithms, and any other information that may be relevant to the chair system 100. More specifically, the controller 1100 may be in communication with the button assembly 700, hand controller 800, and foot controller 900 to identify user preferences through the corresponding user inputs. In one aspect of this disclosure, the controller 1100 communicates wirelessly with the hand and foot controllers 800, 900 utilizing any known form of wireless communication as discussed herein. Further, the hand and foot controllers 800, 900 may each be able to both transmit and receive data to/from the controller 1100 to identify and indicate the current state of the chair system 100. Accordingly, each of the hand and foot controller 800, 900 may also have their own controller with a processor and memory unit therein to allow the corresponding controller 800, 900 to communicate with the controller 1100 to manipulate and display the status of the chair system 100.

The controller 1100 may also communicate with a plurality of sensors of the chair system 100 to identify the current state of the chair system. For example, the controller 1100 may communicate with a phoropter sensor 1102 to identify whether the phoropter 118 is in the stored orientation or in-use orientation. Further, a phoropter height sensor 1104 may communicate with the controller 1100 to identify the height of the phoropter 118. Similarly, a slit lamp deployment sensor 1106 may identify whether the slit lamp 116 is in a stored position rotated away from the patient or an in-use position in front of the patient.

The controller 1100 may also communicate with an instrument deployment sensor 1108, 1110, 1112 in each instrument well of the instrument holding assembly 120. The instrument deployment sensors 1108, 1110, 1112 may identify when an instrument is present in the respective instrument well.

The controller 1100 may also communicate with a chair tilt sensor 1114 to identify the angle of the chair 104 back. Similarly, the controller 1100 may communicate with a chair height sensor 1116 to identify the current height of the chair 104.

While specific sensors are discussed herein, this disclosure considers utilizing other sensors to monitor any position setting of the chair system 100. Further, the sensors discussed herein may be any sensor known in the art capable of identifying the corresponding information.

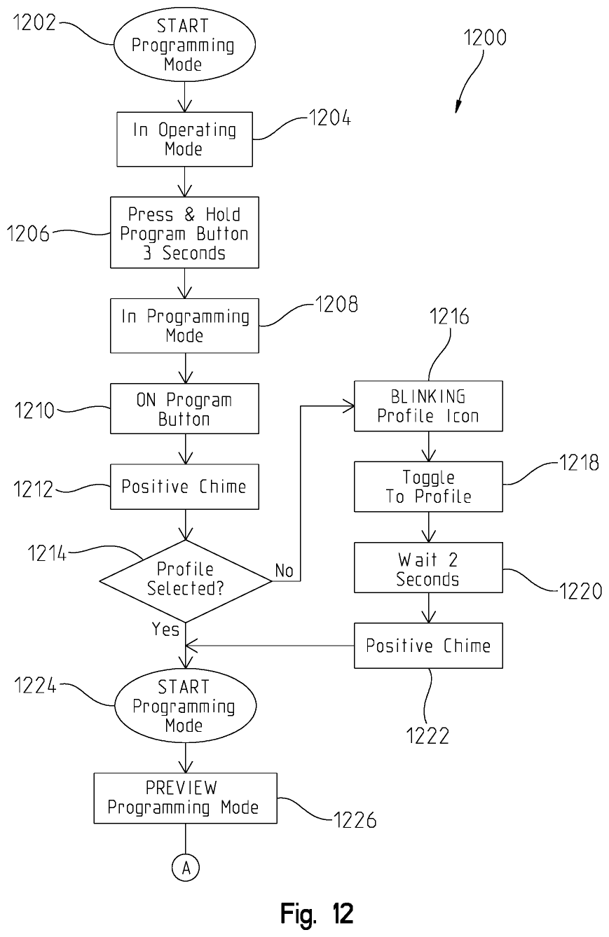

Referring now to FIGS. 12-32, one exemplary embodiment of a programming logic flowchart 1200 for the control system 108 is illustrated. In FIG. 12, the programming mode may start 1202 when in operating mode 1204 and the program button 33 is held for three seconds 1206. In the programming mode 1208, the program button 33 may be illuminated indicating it is in programming mode 1210. Further, an audible chime or the like may indicate the control system 1208 is in programming mode 1212. Once in programming mode, the control system 108 may determine whether a specific profile is selected 1214 via the profile selector 22. If a specific profile has not been selected, the profile icon 23 may blink 1216 indicating that the use must select a profile. The user may toggle through the available profiles by pressing the profile selector 22 until the user identifies the desired profile 1218. The control system 108 may wait about two seconds to ensure the desired profile is selected 1220 before providing an audible chime 1222 confirming the selection. The control system 108 may then start the programming mode 1224 for the selected profile. Once in the programming mode for that profile, the corresponding profile bars 24 may reflect the selected profile to be programmed 1226.

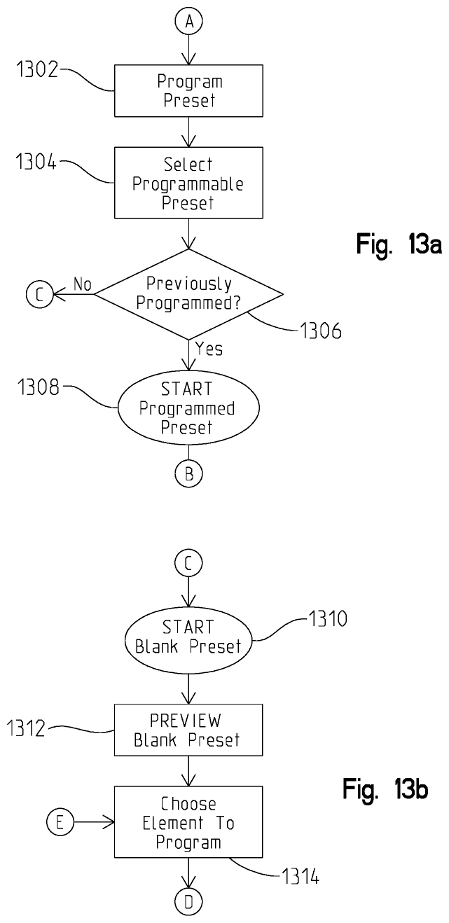

In FIGS. 13a and 13b, the presets 13, 14, 15 may be programmed 1302 by selecting the specific preset to be programmed 1304. If selected preset was previously programmed 1306, the control system 108 may start the programmed preset 1308. If the preset was not previously programmed, the control system 108 will start a blank preset 1310 and illustrate a preview of the blank preset 1312. Next, the control system 108 may select the element to program 1314. The programmable elements may include the instrument wells 120, any of the lights 110 or ambient lighting, and the chair system 100 among others.

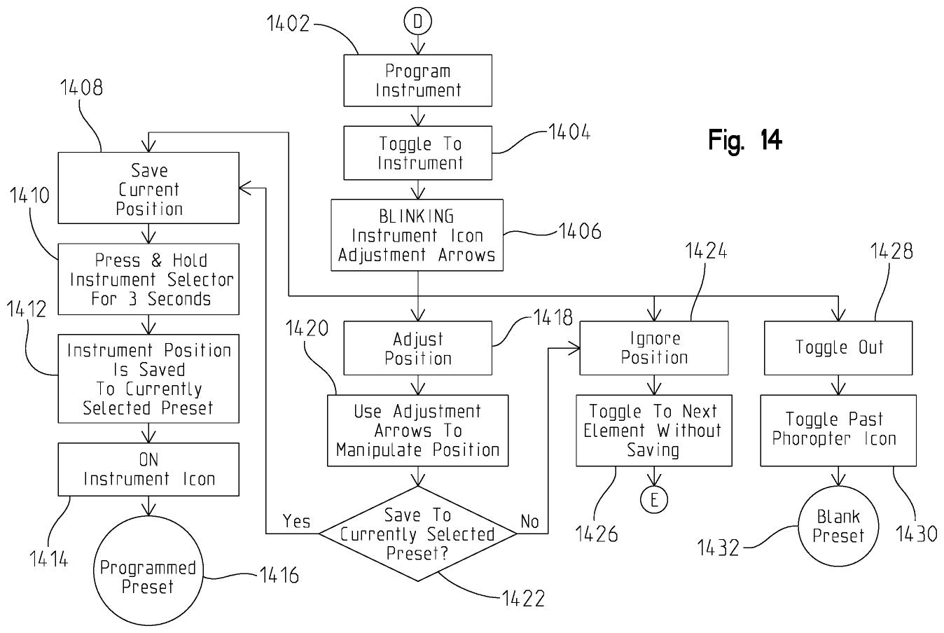

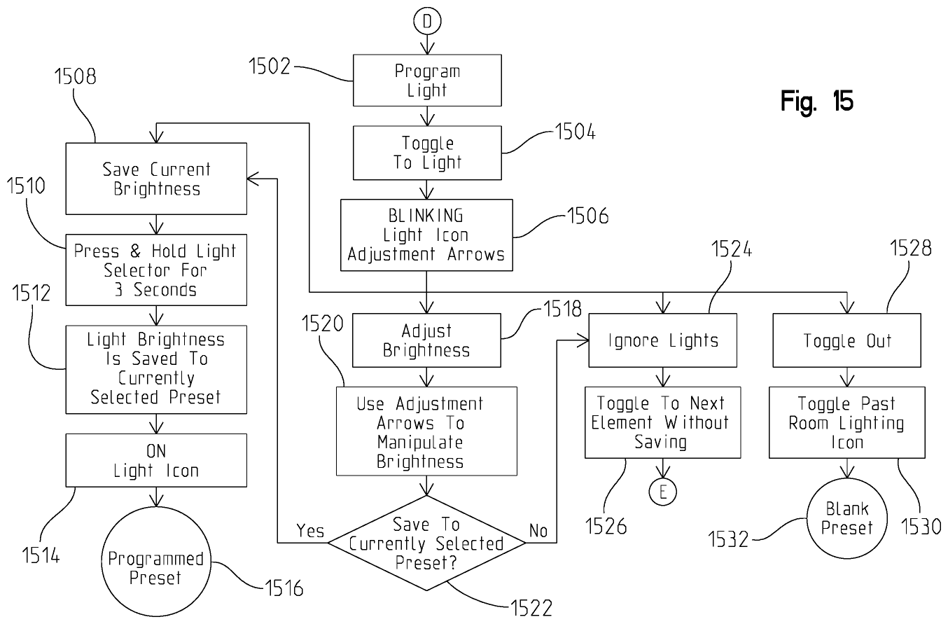

The program an instrument flow chart is illustrated in FIG. 14. The program an instrument 1402 may be selected and toggled to 1404 via the instrument selector button 16. The instrument icon corresponding with the programming may blink 1406 at which point the user may save the current position 1408, adjust the position 1418, ignore position 1424, or toggle out 1428. If the user saves the current position 1408, they may press and hold the instrument selector button 16 for about 3 seconds 1410. Then the instrument position will be saved as the currently selected preset 1412. The instrument icon may then remain solidly on indicating the position was saved 1414 and the preset may be programmed 1416.

If the user wants to adjust the current position 1418, the user may use the adjustment arrows 6, 7, 9, 11 to manipulate the position 1420. Then the user may save the selected location 1422 by incorporating steps 1408-1416 discussed herein. If the user wants to ignore the current position of the instrument 1424 they may toggle to the next element without saving 1426. Similarly, a user may toggle out of the instrument selector 1428 by toggling past the instrument icons 17, 18 in box 1430 and the preset will be blank 1432.

Referring now to FIG. 15, one or more of the lights may be programmed 1502. The user may toggle to the desired light 1504 utilizing the light selector 29. The corresponding selected light icon 30, 31, 32 may then blink 1506 indicating the selection. The current light setting can be saved 1508 by pressing and holding the light selector for about 3 seconds 1510. Then, the light brightness will be saved to the currently selected preset 1512 and the corresponding light icon will remain illuminated 1514 and the programmed preset will complete 1516.

The user may also adjust the brightness 1518 may using the adjustment arrows 26, 28 to manipulate the brightness 1520. The selected brightness may then be saved 1522 utilizing the save configuration discussed herein 1508, 1510, 1512, 1514, 1516. Alternatively, the user may ignore the light preset 1524 and toggle to the next element without saving 1526. Similarly, the user may toggle out 1528 to different icons 1530 and leave the previous icon as a blank preset 1532.

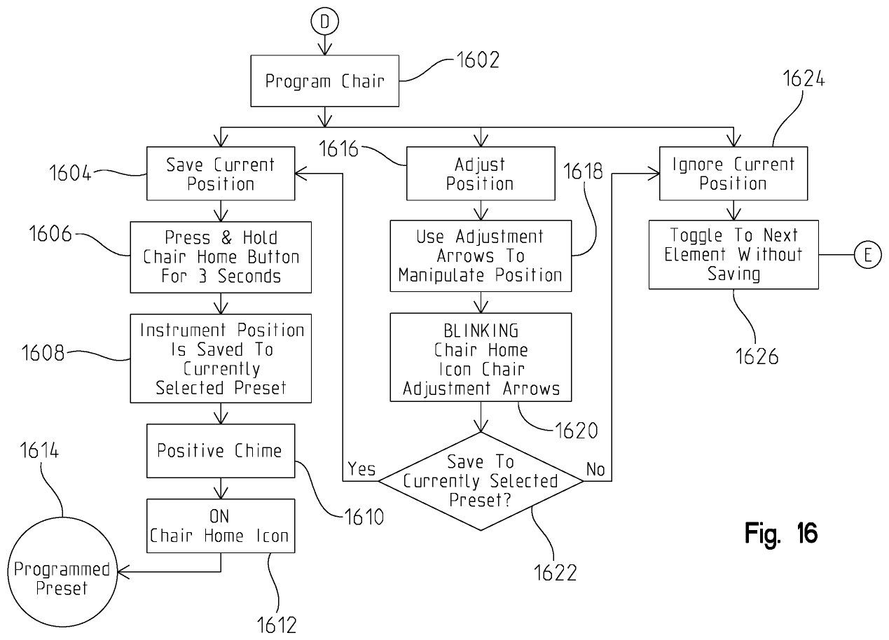

FIG. 16 may illustrate one programming configuration to program the chair system 100. More specifically, the chair program 1602 may allow the user to save the current position 1604, adjust the position 1616, and/or ignore the current position 1624. To save the current position 1604, the user may press and hold the chair home button 10 for about three seconds 1606. The presets may then be saved 1608 and a chime may sound 1610. Further, the chair home icon may remain illuminated 1612 indicating the position is saved and the preset may remain programmed 1614. To adjust the chair 104 position 1616, the user may engage the adjustment arrows 6, 7, 9, 11 to alter the position of the chair 104 in 1618. During the adjustment, the home icon may be blinking 1620 until the position is saved 1622. To save the position, the boxes 1604-1614 may be implemented as discussed herein after the chair is moved to the desired location. Alternatively, the user may ignore the current position 1624 and toggle to the next element without saving 1626.

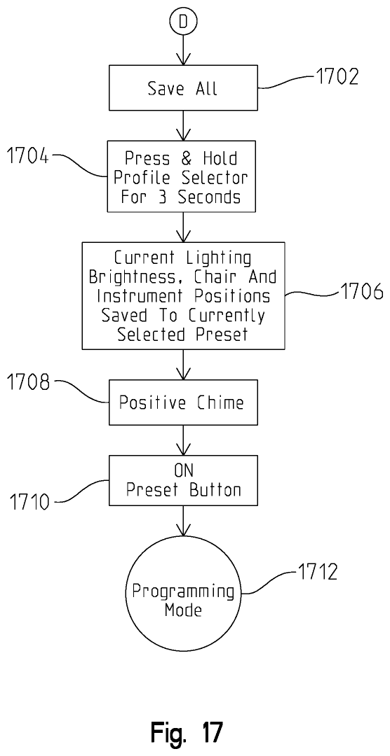

A save all 1702 method is illustrated in FIG. 17. More specifically, a user may press and hold the profile selector 22 for about three second 1704 and the current lighting, chair configuration, and instrument position will be saved to the currently selected preset 13, 14, 15 in 1706. A positive chime may sound 1708 indicating the save and the selected preset button may remain illuminated 1710 as the programming mode is concluded 1712.

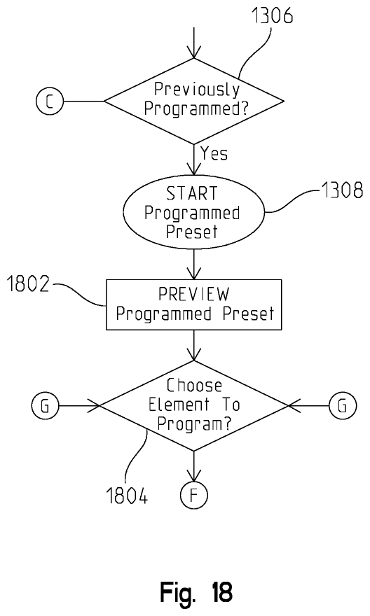

If the preset was previously programmed in 1306, the control system 108 may start the programmed preset 1308 and orient the chair system 100 and surrounding lights in the programmed preset 1802 in FIG. 18. Then, the user may select an element to program 1804. The user may select to program the instruments, lights, or chair 104.

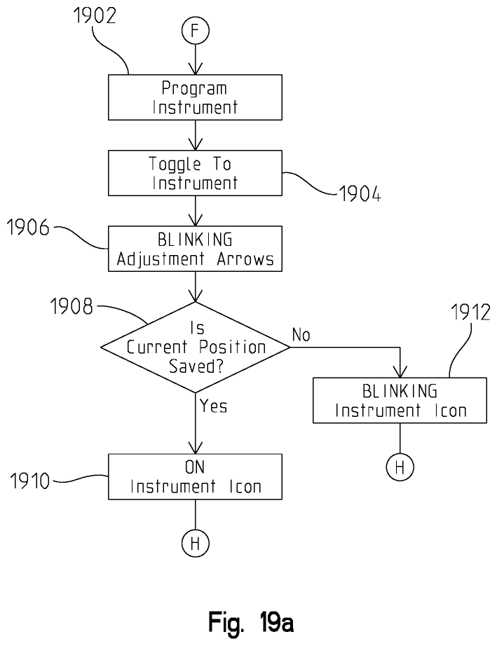

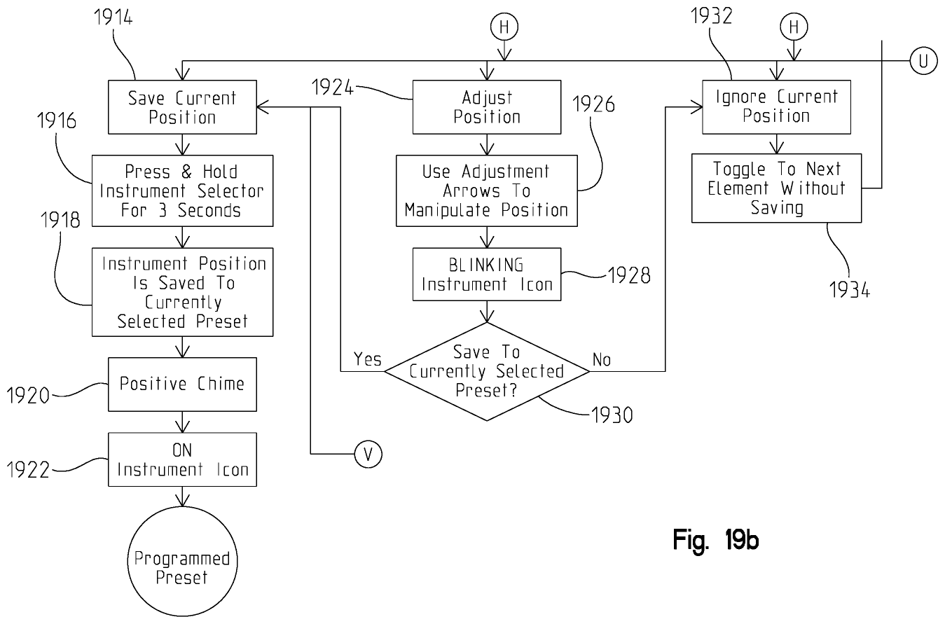

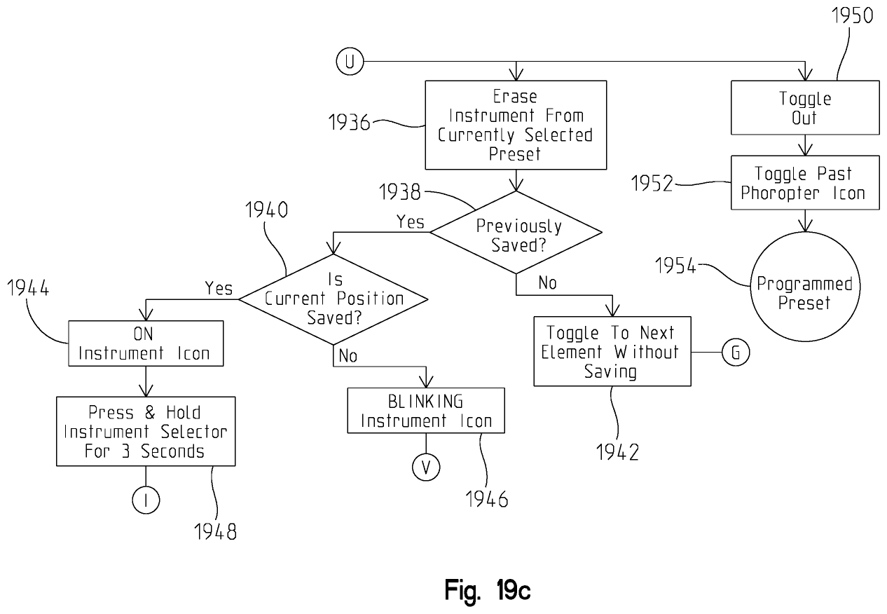

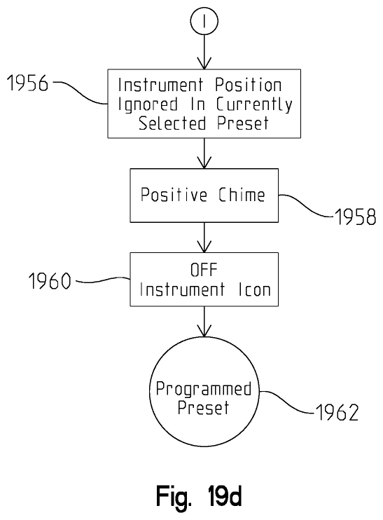

The instruments may be programmed as illustrated in FIGS. 19a-19c. More specifically, to program an instrument 1902 the user may toggle to the instrument 1904 and the corresponding adjustment arrows 20, 21 may blink 1906. If the current position is saved the instrument icon will be solid 1910 and if the current position is not saved the instrument icon will be blinking 1912.

To save the current position 1914, the control system 108 may implement a similar button selection 1916, saving protocol 1918, and chime 1920 and lighting scheme 1922 as discussed herein with reference to FIG. 14. Further, the position of the instrument may be adjusted 1924 utilizing the arrows 20, 21 to manipulate the position 1926. The instrument icon may blink when changed and before it is saved 1928. Once positioned as desired the user may select to save the positioning 1930 utilizing methodology discussed herein starting at box 1914. The user may also elect to ignore the current position 1932 and go to the next element without saving 1934.

The user may also erase the instrument from the current preset 1936. If an instrument was previously saved 1938 the control system 108 will check if the current position is saved 1940. If the current position is not saved the instrument icon may remain blinking 1946. However, if the current position is saved the instrument icon will remain illuminated 1944. The user may then press and hold the instrument selector for about 3 seconds 1948 and the instrument position will be ignored in the currently selected preset 1956. This may be signified by a chime 1958 and the instrument icon may turn off 1960 before concluding the preset 1962.

In one aspect of this disclosure, the user may toggle out of the instrument preset 1950 by going past the phoropter icon 18 to conclude that section of the preset 1954.

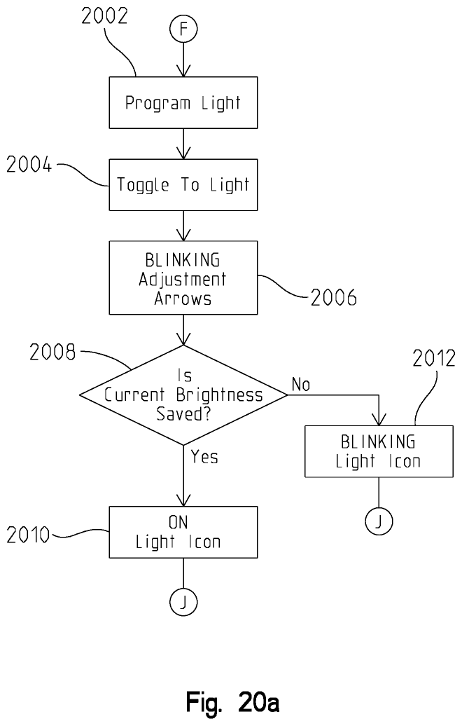

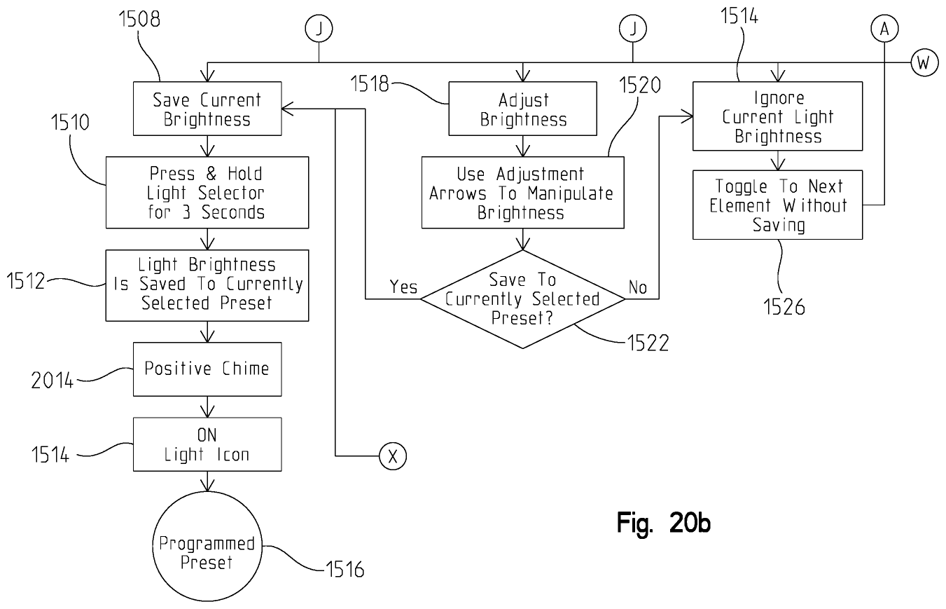

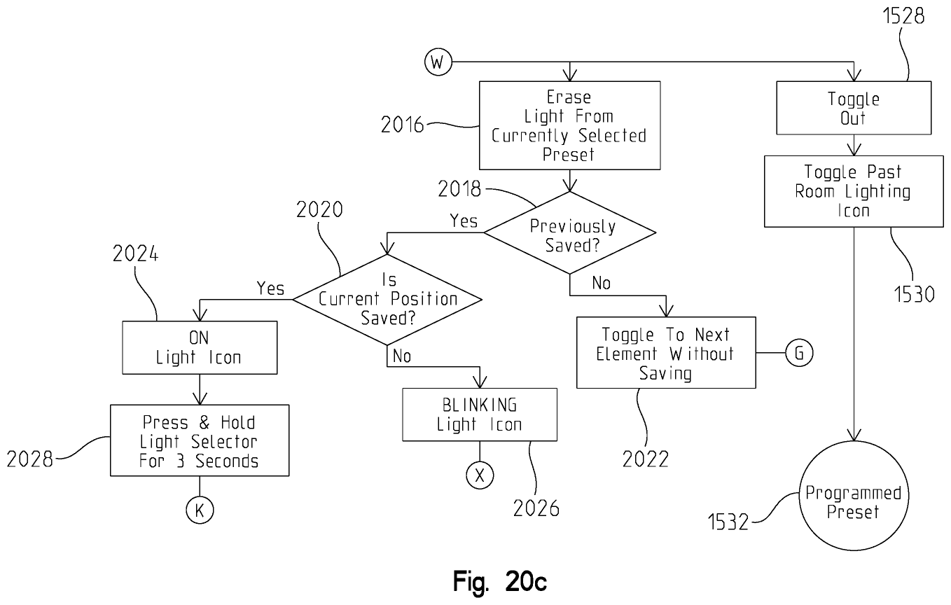

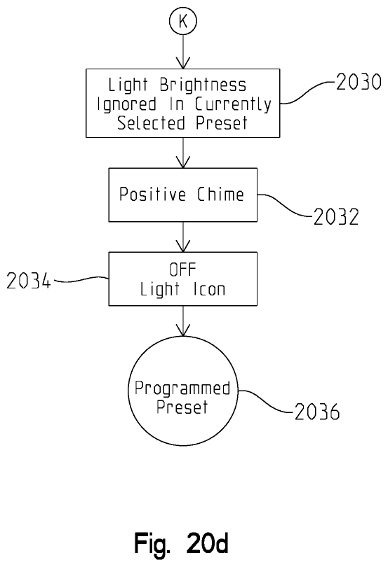

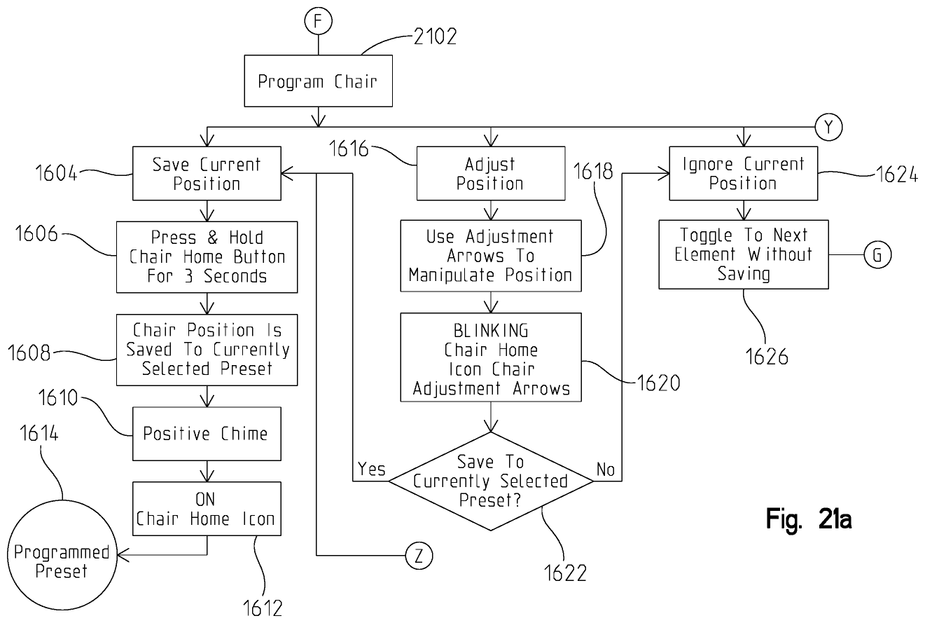

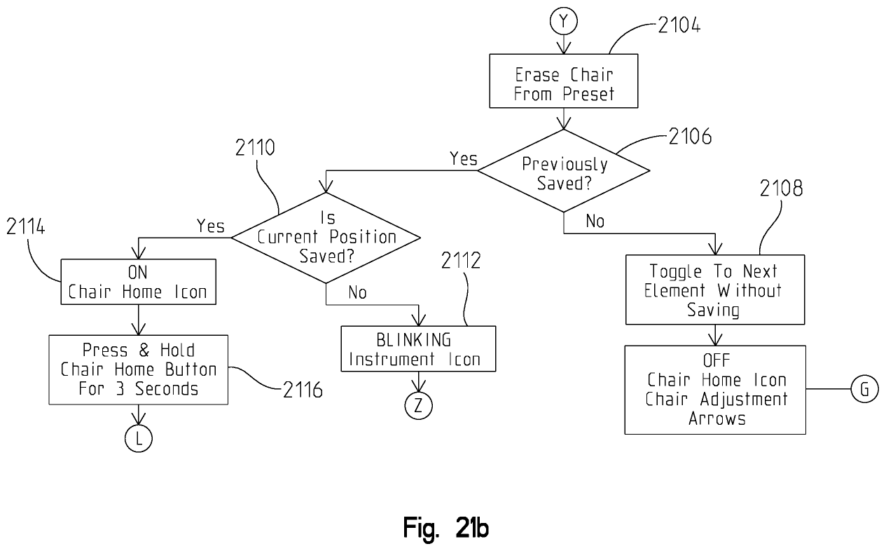

One or more of the preset lights may be programmed 2002 as illustrated in FIG. 20. The light selector 29 may toggle to the desired light 2004 wherein the arrows 20, 21 may be blinking, indicting the brightness may be adjusted. If the current brightness is saved 2008, the corresponding light icon may remain illuminated. If not, the corresponding light icon may be blinking.

The current brightness 1508 may be saved utilizing a similar methodology as discussed with reference to FIG. 15 except a chime may be implemented for a successful save operation 2014. Similarly, the brightness may be adjusted 1518, 1520, 1522, the current brightness can be ignored 1514, 1526, and the toggle out option 1528, 1530, 1532 of FIG. 20b may be substantially the same as that discussed in FIG. 15.

However, a user may erase a light from a currently selected preset 2016 if a light configuration was previously saved 2018. If a previous element was not saved 2022, the control system 108 may toggle to the next element without saving. However, if a light configuration was previously saved the control system 108 may determine whether the current position is the saved position 2020. If it is not, the light icon may remain blinking. However, if the current configuration of the light is the saved configuration, the corresponding light icon may remain lit 2024. The user may press and hold the light selector 29 for about 3 seconds 2028 to indicate that the light configuration should be ignored in the currently selected preset 2030. A chime may sound 2032 indicating the change and the light icon may turn off 2034 as the preset is programmed accordingly 2036.

A program chair 2102 for a preset chair configuration may have substantially the same save current position 1604, adjust position 1616, and ignore current position 1624 protocols as discussed herein for FIG. 16. However, the preset chair configuration may be erased 2104 in this portion. The control system may check if a chair configuration was previously saved 2106. If a chair configuration was not previously saved 2108, the chair home icon may turn off indicating there is no saved chair configuration. If a previous configuration was saved, the control system 108 will check whether the current position is the saved position 2110. If the current position is not the saved position, the chair home icon 10 may remain blinking in 2112. However, if the current position is the saved position, the chair home icon 10 may remain solidly illuminated 2114. Next, the user may press and hold the chair home button 10 for about three seconds 2116. Responsive to this input, the chair position will be ignored for the selected preset 2118. This will be indicated with a chime 2120 and the chair home icon and arrows will no longer be illuminated as the preset is programmed 2124.

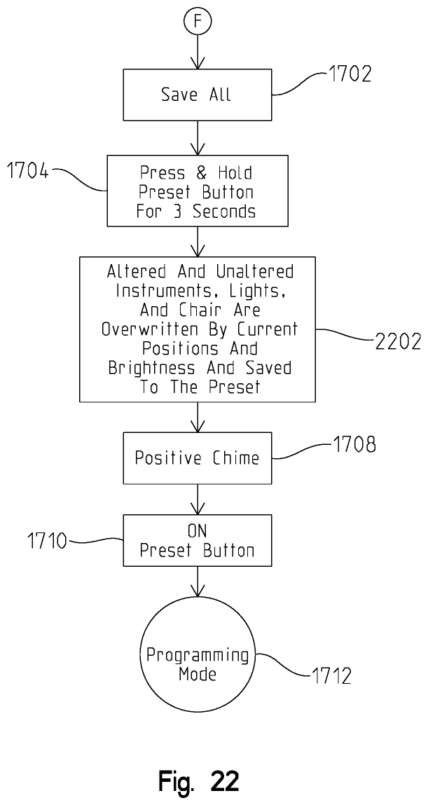

A save all option 1702 may also be selected for configurations having pre-configured presets as illustrated in FIG. 22. This may implement substantially the same logic as presented in FIG. 17 with the addition that the previously saved configurations are overwritten 2202.

In one aspect of this disclosure program profile preferences 2302 may be selected 2304 utilizing profile selector 22. The control system 108 may check whether a profile was previously programmed 2306. If there is a pre-programmed profile, the programmed profile may be entered 2308 and previewed 2310. In the preview, the user may select an element to program 2312.

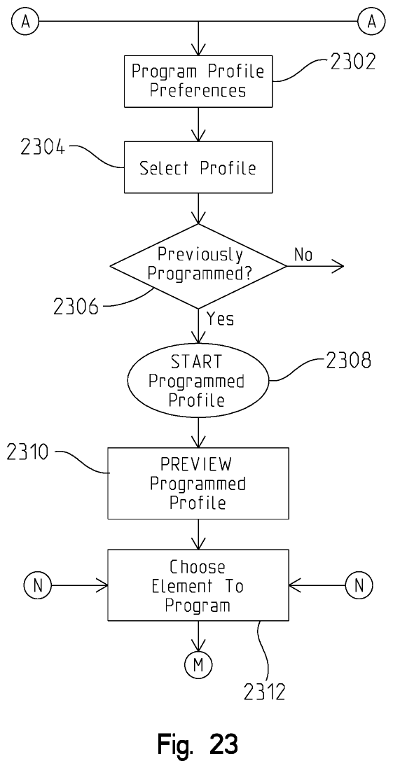

Programmable elements may include instruments and lights among other things. The instruments may be programmed in substantially the same ways as illustrated and described with reference to FIGS. 19a-19c except that the terminating node will be diverted to node “N” of FIG. 23 rather than node “G.” Similarly, the lights may be programed similarly as described for FIGS. 20a-20c with the exception that the terminating node is diverted to node “N” rather than node “G.” Further, a save all functionality is also available under the program profile preferences section implementing substantially the same logic as explained with reference to FIG. 22.

Further, if a profile was not previously programmed at box 2306, instrument and light profiles may be generated using substantially the same logic discussed with reference to FIGS. 14 and 15. As such, those sections are incorporated herein for the program profile preferences 2302 as well although they will not be repeated herein.

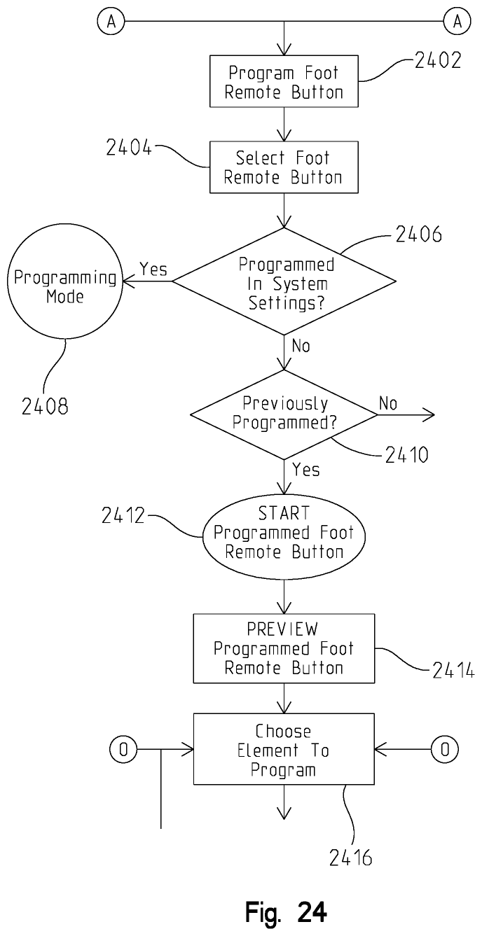

The foot controller 900 can also be programmed as outlined starting at FIG. 24. More specifically, the program foot remote button 34 may be engaged 2402 by a user 2404. The control system 108 may check if the foot remote is programmed in the system settings 2406. If the foot remote was programmed, it may go into programming mode 2408. If note, the control system 108 may check whether the foot remote was previously programmed 2410. If it was, the corresponding programmed protocol will be initiated 2412 and the foot controller 900 will be configured in a preview of the programmed settings. In the preview, a user may select the elements to program 2416. Programmable elements include, but are not limited to, instruments, lights, and the chair configuration.

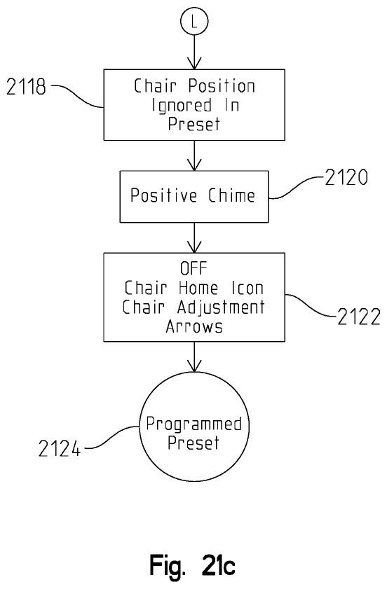

The programmable elements of the foot controller 900 may include instruments programmed in substantially the same ways as illustrated and described herein with reference to FIGS. 19a-19c except that they are associated with the buttons of the foot controller 900 and the terminating node will be diverted to node “0” of FIG. 24 rather than node “G.” Similarly, the lights may be programed similarly as described for FIGS. 20a-20c with the exception that the settings are associated with the foot controller 900 and the terminating node is diverted to node “0” rather than node “G.” The chair 104 may be programed similarly as described for FIGS. 21a-21b with the exception that the settings are associated with the foot controller 900 and the terminating node is diverted to node “0” rather than node “G.” Further, a save all functionality is also available under the program profile preferences section implementing substantially the same logic as explained with reference to FIG. 22.

Further, if the foot controller was not previously programmed at box 2406, instrument, light, and chair preferences may be generated for the foot controller using substantially the same logic discussed with reference to FIG. 14 for the instruments, FIG. 15 for the lights, and FIG. 16 for the chair except the corresponding preferences are associated with the foot controller 900 and the terminating nodes are “0” instead of “E.” Further, a save all functionality is also available under the foot controller preferences section implementing substantially the same logic as explained with reference to FIG. 17.

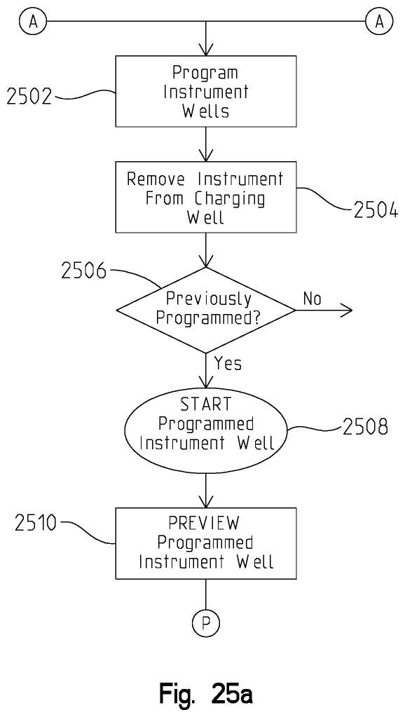

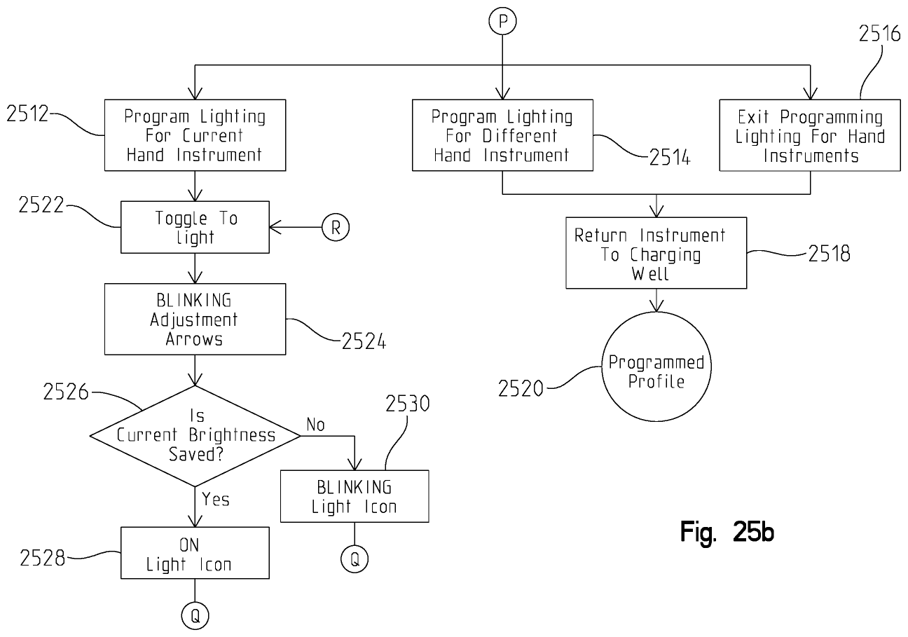

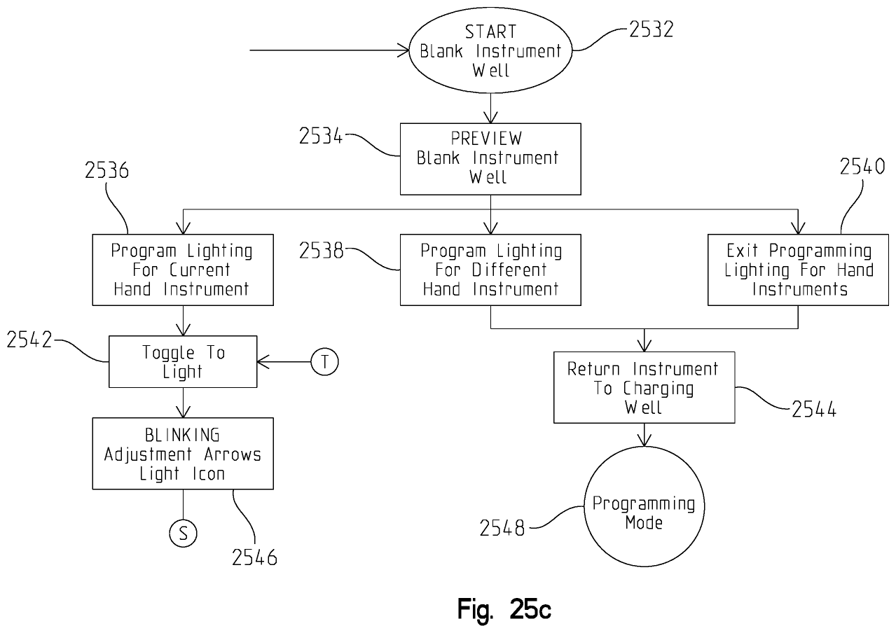

Referring now to FIG. 25 the instrument holding assembly 120 may be programmed 2502. Initially, the instruments may be removed from their corresponding charging well 35, 36, 37 in box 2504. Then the control system 108 may consider whether the instrument holding assembly 120 was previously programmed 2506. If it was previously programmed, the programmed instrument well protocol 2508 may begin by previewing the instrument well configuration programmed therein 2510. The user may select whether to program lighting for the current hand instrument 2512, program lighting for a different hand instrument 2514, or to exit the programming for the instruments 2516. If the user chooses to program a different instrument 2514 or exit the programming 2516, the user will preferably return the hand instrument to the corresponding charging well 2518 and enter the programmed profile 2520.

If the user decides to program the lighting of the current hand instrument 2512, the user may toggle to light 2522. In this configuration, the adjustment arrows 20, 21 may be blinking 2524 and the control system 108 will determine whether the current brightness of the hand instrument is saved 2526. If the current brightness is saved, the light icon may remain solidly illuminated 2528. However, if the current brightness is not saved, the light icon may be blinking 2530. Regardless, the control system may then allow for programming the light of the hand instrument utilizing substantially the same logic from FIGS. 20b-20a except the setting are associated with the hand instrument and terminating node “G” from those figures is replaced by node “R.”

Of the instruments associated with the instrument holding assembly 120 were not previously programmed in box 2506, the blank instrument well protocol 2532 of FIG. 25c may begin. The blank instrument well protocol 2532 may provide a preview of the blank instrument well 2534 and allow the user to either program lighting for the current hand instrument 2536, program lighting for a different hand instrument 2538, or exit the programming for a hand instrument 2540. If the user elects to program a different hand instrument 2538 or exit the programming 2540, the control system 108 may recommend returning the instrument to the corresponding charging well 35, 36, 37 in 2544 and enter programming mode 2548. Alternatively, if the user wants to program the current hand instrument 2536, the user may toggle to light 2542 and the adjustment arrows 20, 21 may blink 2546. The light may then be adjusted using substantially the same logic explained with reference to FIG. 15 except the preset is associated with a hand instrument and the terminating node “E” is directed to node “T” of FIG. 25c.

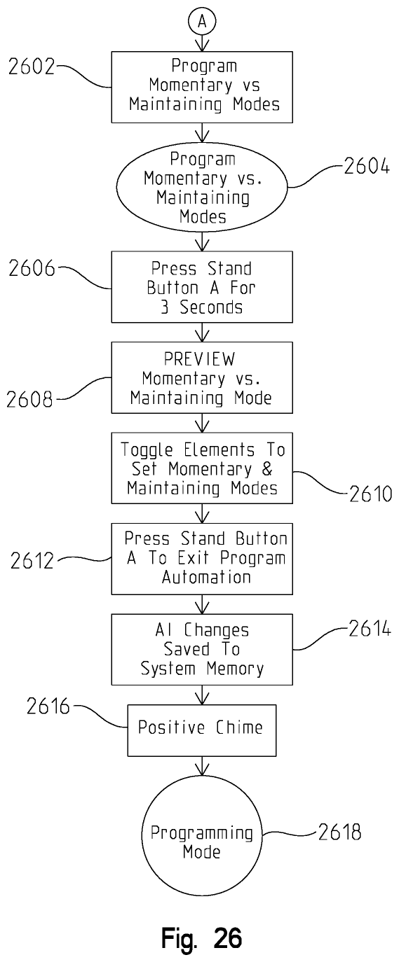

Referring to FIG. 26, the control system 108 may program momentary and maintaining modes 2602, 2604. In this mode, the user may press the first stand button 3 for about three seconds 2606 to enter a preview mode 2608. At this point, the user may toggle between momentary and maintaining modes 2610. Once the desired mode is selected, the user may press the first stand button 3 to exit the programming mode 2612. The changes may then be saved to the system memory 2614 and a positive chime may sound 2616 prior to completing programming mode 2618.

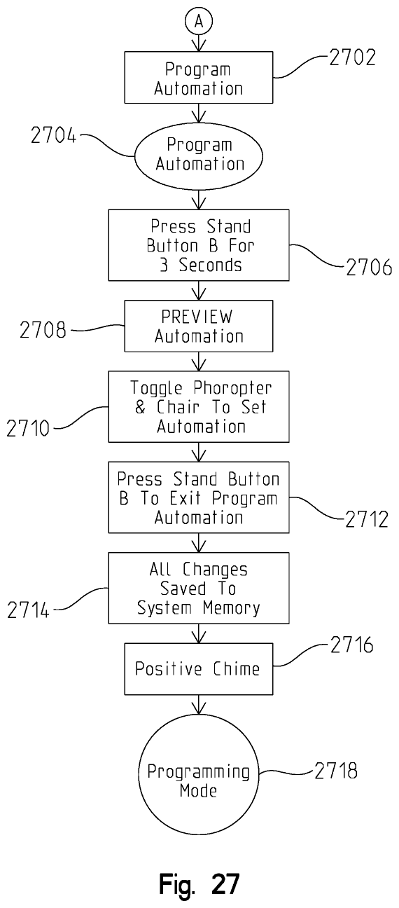

Similarly referring to FIG. 27, the control system 108 may program automation modes 2702, 2704. In this configuration, the user may press the second stand button 4 for about three seconds 2706 to enter a preview mode 2708. At this point, the user may toggle the phoropter 118 and the chair 104 to set automation 2710. Once the automation is set, the user may press the second stand button 4 to exit the programming mode 2712. The changes may then be saved to the system memory 2714 and a positive chime may sound 2716 prior to completing programming mode 2718.

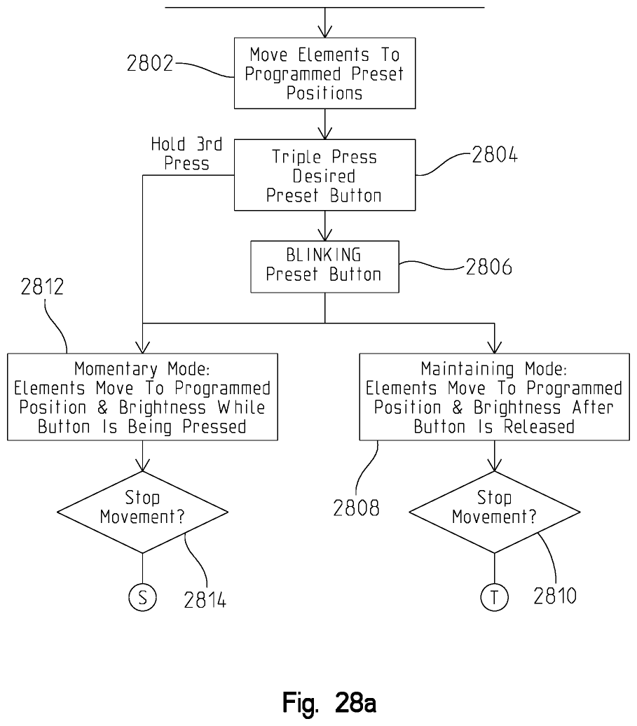

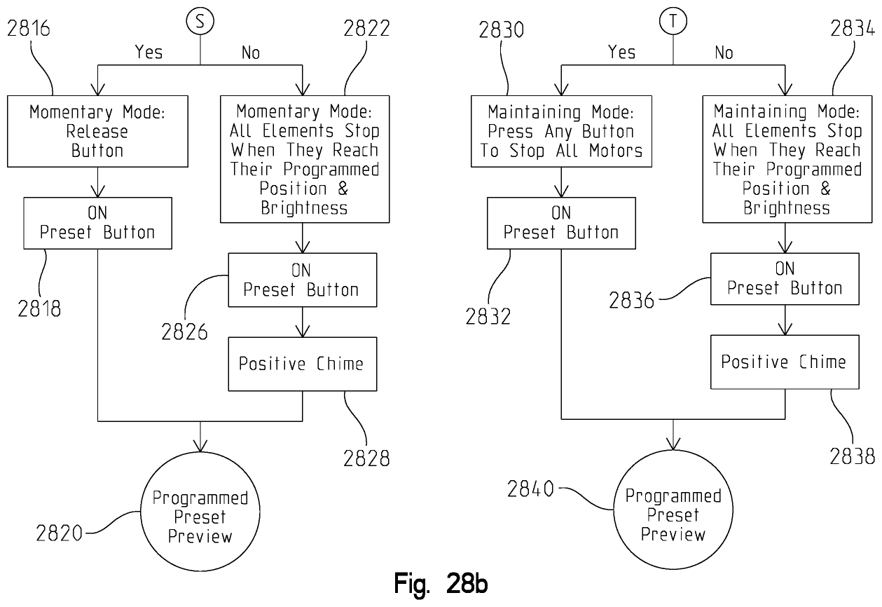

In another aspect of this disclosure elements may be moved to program preset positions 2802 as outlined in FIGS. 28a-28b. More specifically, the desired preset button 13, 14, 15 may be pressed three time 2804 and the corresponding button may then begin blinking 2806. At this point, the user may select between a maintaining mode 2808 wherein elements moved to the programmed positions and brightness after the button is released and a momentary mode 2812 wherein the elements only move to the programmed positions and brightness while the corresponding button is pressed.

In momentary mode, movement is stopped on release of the corresponding button 2816 and the button will remain illuminated 2818 before ending 2820. In momentary mode, all elements stop changing when they reach their programmed configurations 2822. Once all elements reach their programmed configuration, the button light remains illuminated 2826 and a chime may sound 2828 before the logic is terminated.

In maintaining mode, when any button is pressed all elements may stop changing 2830 and the corresponding preset button may remain illuminated 2832 before ending the program 2840. Similarly, all elements will stop when they reach their corresponding programmed configuration in maintaining mode 2834. Once in their programmed configuration, the corresponding button may remain illuminated 2836 and a chime may sound 2838 before terminating 2840.

The foot remote 900 may similarly be able to select either a momentary mode or a maintaining mode for responding to certain user inputs. Further still, the home button 10 may be selectable to return the chair system 100 to a home configuration utilizing either the momentary mode or the maintaining mod.

In one non-exclusive example, a single button press may implement the maintaining mode while a three button press with a hold on the third press may initiate the momentary mode.

In yet another example, the remote system 108 may be programmed to implement either the momentary mode or the maintaining mode when a user input is identified.

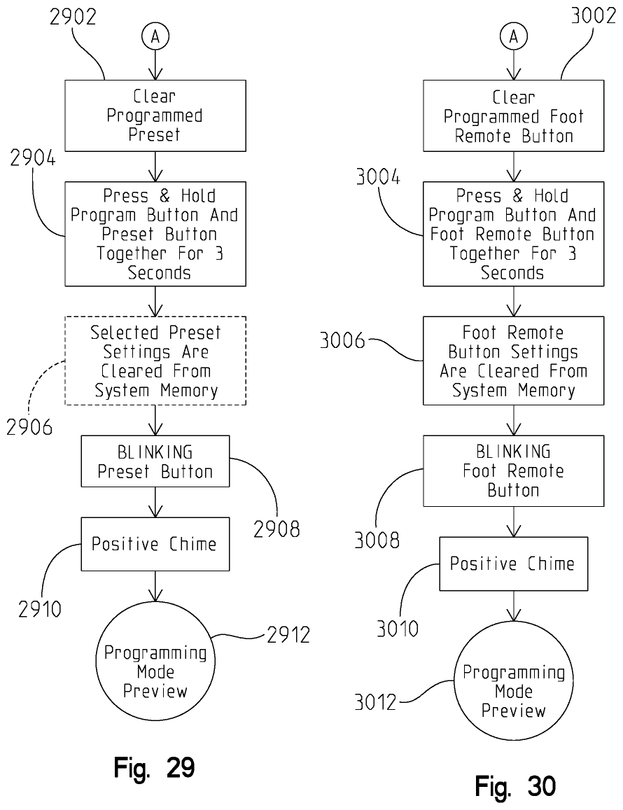

Referring now to FIG. 29, the programmed preset may be cleared 2902. More specifically, a user may press and hold the program button and a preset button (13, 14, or 15) at the same time for about three seconds 2904 to enter this mode. Then, the selected preset settings will be cleared from the system memory 2906. In this configuration, the selected preset button may be blinking 2908 and a positive chime may sound 2910 indicating the memory was cleared before returning 2912.

Referring now to FIG. 30, the foot controller 900 presets may similarly be cleared 3002. More specifically, a user may press and hold the program button and a foot controller button at the same time for about three seconds 3004 to enter this mode. Then, the selected preset settings associated with the foot controller 900 will be cleared from the system memory 3006. In this configuration, the selected preset button may be blinking 3008 and a positive chime may sound 3010 indicating the memory was cleared before returning 3012.

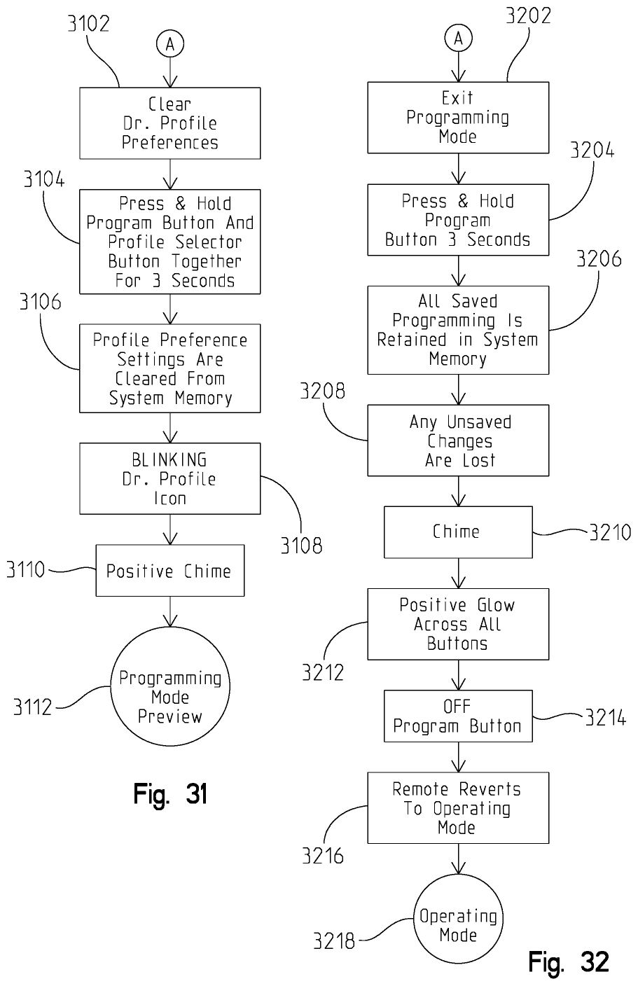

The doctor profile presets may also be cleared 3102 as illustrated in FIG. 31. The user may press and hold the program button 33 along with the profile selector button 22 for about three seconds 3104 to clear the profile preference settings from the memory 3106. Responsive to this action, the doctor profile icon 23 may blink 3108 and a chime may sound 3110 before returning to a different mode 3112.

FIG. 32 illustrates one method to exit the programming mode 3202. The program button 33 may be pressed for about 3 second 3204 and all saved programming will be retained in the system memory 3206 and any unsaved changes will be discarded 3208. A chime may sound indicating the change 3210 an a all buttons may be illuminated 3212. Then the program button 33 may turn off 3214 and the controller system 108 reverts to operating mode 3216 for further use 3218.

The flow charts discussed herein are generally referred to as being executed by the control system 108. However, this disclosure contemplates executing this logic with any one or more controller, processor, and or memory unit capable of storing information and executing commands. For example, the controller 1100 may execute the flow charts discussed herein. Further still, each of the hand controller 800 and the foot controller 900 may have a separate controller and memory unit that separately executes some or all of the logic steps discussed herein.

Further, several steps discussed herein refer to time intervals for button presses such as three seconds. These time intervals are examples of one embodiment and other embodiments may have time intervals with more or less time.

Other embodiments of this disclosure may have shortcut programmed into the controller system 108. For example, the chair home button 10 may be pressed three consecutive times to move the chair 104, instruments 116, 118, 120, and lights 110 to a home configuration. Similarly, when the phoropter 118 is selected on the instrument selector 16 and the instrument up arrow 20 is selected two times the phoropter 118 may move to a home position. Further, if the slit lamp icon 17 is held for about three seconds, the slit lamp 116 may be moved to the doctor preset location. Similarly if the phoropter icon 18 is held for about three seconds the phoropter 118 may move to the doctor's preferred orientation. The doctor profile icon 23 may also be held for about three second to move all elements to the programmed preferred configuration. The lighting down arrow 26 may be tapped twice to turn off all lights. Similarly the lighting up arrow 28 may be tapped twice to turn all lights on to their last brightness level. The ambient light icon 30, direct light icon 31, or room light icon 32 may also be pressed for about three seconds to change the ambient brightness of the corresponding light assembly 110 or room light to the programmed preference for the selected doctor.

In use, the chair 104 may adjusted using the buttons 6, 7, 8, 9, 10, 11, or 12. The buttons may move the chair one when pressed if in momentary mode or until the movement is complete if in maintaining mode. The chair 104 may also automatically move to a preset configuration when a preset 13, 14, 15 is selected having a programmed chair configuration.

The slit lamp 116 may also be configured to rotate about a slit lamp axis 122 and raise/lower along the axis 122 to a preferred orientation. The slit lamp 116 may be manually rotated about the axis 122 or automatically via one or more motor or the like. The movement of the slit lamp 116 may be controlled by the instrument control buttons 20, 21 or automatically when associated with a preset orientation preference programmed as discussed herein.

The phoropter 118 may similarly be rotated or raised/lowered about a phoropter axis 124 to a preferred orientation. The movement of the phoropter 118 may be controlled by the instrument control buttons 20, 21 or automatically when associated with a preset orientation preference programmed as discussed herein.

Ambient light of the light assembly 110 may be a light that is directed generally away from the chair 104 to light other areas of the room. The control system 108 may turn the ambient light of the light assembly 110 on/off, adjust the brightness, and automatically change any of these characteristics to match programmed presets as discussed herein.

Similarly, the light assembly 110 may have a direct light that is oriented to cast light directly towards the chair 104. The control system 108 may turn the direct light of the light assembly 110 on/off, adjust the brightness, and automatically change any of these characteristics to match programmed presets as discussed herein.

Further still, in one embodiment of this disclosure the control system 108 may communicate with a room lighting system. In this configuration, the control system 108 may also control the room lighting of an exam room or the like. The control system 108 may turn the room light on/off, adjust the brightness, and automatically change any of these characteristics to match programmed presets as discussed herein.

In one aspect of this disclosure, biometric data may be used by the control system 108 to automatically identify the profile implemented by the control system. More specifically, the profile selector may have access to one or more of a fingerprint reader or a camera configured to communicate with the control system the corresponding user. If the biometric data of the user is associated with a programmed profile the profile selector 22 will automatically set the control system 108 to that particular user profile. In this configuration, all presets of the user profile may automatically be implemented when the control system 108 identifies the user via the biometric data.

The chair system 100 may also have a camera or the like for scanning patients to identify the height and other ergonomic data. Alternatively, the chair system 100 may use a laser, or any other spatial sensing technology to establish preferred orientations of the chair 104 and the corresponding instruments based on the identified patient's size.

Similarly, one embodiment includes a weight sensors in chair 104 to detect when a patient is positioned therein. The weight sensor may be utilized by the control system 108 to identify the duration of an examination and the number of examinations that occurred in a given period of time. The weight sensor, or any similar sensor, may be utilized for data logging to track the number of patients seen, time spent in each phase of exam, and any other patient related data.

The control system 108 may also implement a smart deployment of instruments using height sensors 1104, 1106, 1116 to avoid collisions between instruments or impact to patient or user. In one non-exclusive example, the control system 108 will restrict the height of the chair 104 if it senses that the slit lamp 116 positioned over the patient. Further, the control system 108 may automatically set the height of the phoropter 118 based on the current preset position of the slit lamp 116. More specifically, the control system 108 may consider the height of the particular slit lamp 116 being used to deduce the appropriate phoropter 118 height based on distance from phoropter arm to eye line of phoropter 118.

Generally, as discussed herein, the slit lamp 116 and phoropter may automatically raise or lower to the preset position upon deployment, requiring no additional action. In this configuration, when the medical professional selects to move either the slit lamp 116 or the phoropter 118 to be orientated towards the patient, the height of the phoropter slit lamp 116 or phoropter 118 may automatically be adjusted by the control system 108 to the preset position upon deployment.

While exemplary embodiments incorporating the principles of the present disclosure have been disclosed herein, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains.

The terminology used herein is for the purpose of describing particular illustrative embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations)

1. A system for a medical chair, comprising:
a chair assembly having a plurality of movable components;
a control system that selectively controls the movable components; and
a wireless controller that communicates wirelessly with the control system to modify a configuration of the movable components.

2. The system of claim 1, further wherein the wireless controller includes both a wireless foot controller and a wireless hand controller both in communication with the control system.

3. The system of claim 1, further wherein the wireless controller has an elevation button that instructs the control system to raise or lower the chair assembly.

4. The system of claim 3, further wherein the wireless controller has a tilt button that instructs the control system to move the chair assembly toward a reclined or upright position.

5. The system of claim 1, further wherein the wireless controller has at least one preset button that communicates to the control system a preset configuration of the chair assembly when depressed.

6. The system of claim 5, further wherein the preset button also communicates an illumination level of a light source to the control system when depressed.

7. The system of claim 1, further wherein the wireless controller has a lighting rocker that selectively communicates an illumination level to the control system when depressed, wherein the control system alters the illumination level of a light source responsive to input from the lighting rocker.

8. The system of claim 7, further comprising a lighting toggle on the wireless controller that selects one light source of a plurality of light sources to be altered by the lighting rocker.

9. The system of claim 7, further comprising a light level indicator on the wireless remote that is configured to indicate the lighting level of the light source.

10. A chair assembly control system, comprising:
a movable chair assembly having a selectively movable chair thereon;
an equipment support section configured to hold at least one instrument; and
a controller configured to selectively alter the orientation of the chair and the orientation of the at least one instrument on the equipment support section;
wherein, the controller is programmable to automatically alter the orientation of the chair and the at least one instrument responsive to a user input.

11. The control system of claim 10, further comprising a light on the equipment support that is selectively powered by the controller responsive to the user input.

12. The control system of claim 10, further wherein the chair has a plurality of sensors coupled thereto to identify the orientation of the chair and the user input is programmable to alter the orientation of the chair to a programmed orientation when the user input is selected.

13. The control system of claim 12, further wherein the equipment support has a plurality of sensors coupled thereto to identify the orientation of the at least one instrument and the user input is programmable to alter the orientation of the at least one instrument to a programmed orientation when the user input is selected.

14. The control system of claim 10, further comprising at least one programmable preset wherein a user can select a preferred orientation of the chair and the at least one instrument to be associated with the at least one programmable preset.

15. The control system of claim 14, further wherein at least one lighting setting is selected to be associated with the at least one programmable preset.

16. The control system of claim 10, further comprising an instrument holding assembly configured to hold a portable instrument, wherein the controller is programmable to automatically alter a setting of the portable instrument responsive to the user input.

17. A method for controlling an examination room having a medical chair assembly, comprising:
providing a control system in communication with a chair assembly, an equipment support section, a light assembly, and at least one portable controller; and
selectively controlling the orientation of the chair assembly, at least one instrument support of the equipment support section, and the light assembly responsive to an input on the at least one portable controller.

18. The method of claim 17, further wherein the at least one portable controller is at least one of a wireless hand controller and a wireless foot controller that communicate with a controller of the control system wirelessly.

19. The method of claim 17, further comprising:
providing at least one preset input on the at least one portable controller;
selectively programming the at least one preset input to establish a specific orientation of the chair assembly and the at least one instrument of the equipment support section; and
automatically altering the positioning of the chair assembly and the at least one instrument of the equipment support section to the specific orientation when the at least one preset input is selected by a user.

20. The method of claim 19, further wherein the selectively programming the at least one preset input establishes a lighting preference for at least one of a lighting assembly of the equipment support section and a lighting system of the examination room.
